(19) United States
(12) Patent Application Publication
(10) Pub. No.: US 2018/0317020 A1
(43) Pub. Date: Nov. 1, 2018

(54) SPEAKER AND IMAGE DISPLAY APPARATUS

(71) Applicant: TOKIN Corporation, Sendai-shi (JP)

(72) Inventors: Yoshiyuki ABE, Sendai-shi (JP); Mitsuharu CHIBA, Sendai-shi (JP); Katsunori KUMASAKA, Sendai-shi (JP)

(21) Appl. No.: 15/944,045

(22) Filed: Apr. 3, 2018

(30) Foreign Application Priority Data
Apr. 26, 2017 (JP) 2017-087228

(51) Int. Cl. H04R 17/10; H04R 7/04; H04R 1/28

(52) U.S. Cl. CPC H04R 17/10; H04R 1/283; H04R 7/04

(57) ABSTRACT

A piezoelectric speaker according to one aspect of the present disclosure includes: a plurality of piezoelectric elements; a plurality of diaphragms vibrated by expansion/contraction of the plurality of piezoelectric elements, the plurality of diaphragms each having a rectangular principal surface; and a cover that has a box shape and is arranged to cover one surface of the principal surface of each of the diaphragms, the cover being arranged so that an air chamber is formed between the cover and the one surface of the principal surface of each of the diaphragms, in which the lengths of the long sides of the principal surfaces of the plurality of diaphragms are different from one another, and the cover includes an opening formed on one of surfaces of the cover perpendicular to the principal surface of each of the diaphragms.

### INCORPORATION BY REFERENCE

This application is based upon and claims the benefit of priority from Japanese patent application No. 2017-087228, filed on Apr. 26, 2017, the disclosure of which is incorporated herein in its entirety by reference.

### BACKGROUND

The present disclosure relates to a speaker and an image display apparatus including a diaphragm vibrated by a piezoelectric element and the like.

A piezoelectric speaker including a piezoelectric element that is vibrated upon receiving an electric signal, and a diaphragm that is vibrated by expansion/contraction of the piezoelectric element and emits a sound is known. Japanese Unexamined Patent Application Publication No. 2008-199266 discloses a piezoelectric speaker including a case whose internal space is separated into a front air chamber and a rear air chamber by a diaphragm, a sound-emitting hole that communicates the front air chamber of the case with the exterior, and an open hole that communicates the rear air chamber of the case with the exterior. Further, Japanese Unexamined Patent Application Publication No. H06-138882 discloses a piezoelectric speaker including a case body having a double-sided open tubular shape, the case body including an open surface closed by the diaphragm, and a sound-emitting hole being formed in a cylinder wall part of this case body. International Patent Publication No. WO 2017/029768 discloses a piezoelectric speaker including a plurality of vibration transfer structures, each including a piezoelectric element, a diaphragm, and a spacer that couples together the piezoelectric element and the diaphragm.

### SUMMARY

The thickness and the size of piezoelectric speakers can be reduced more easily than those of conventional electromagnetic speakers. Therefore, efforts have been made to apply the piezoelectric speakers to audio/visual equipment such as flat TVs or tablet PCs. In order to apply the piezoelectric speakers to the audio/visual equipment, the piezoelectric speakers need to be able to output a high sound pressure in a wide band.

It has been assumed that the piezoelectric speakers disclosed in Japanese Unexamined Patent Application Publication Nos. 2008-199266 and H06-138882 are applied to applications such as an alarm buzzer and the like where it is required to output a high sound pressure in a specific frequency. That is, in the piezoelectric speakers disclosed in Japanese Unexamined Patent Application Publication Nos. 2008-199266 and H06-138882, a specific frequency is resonated in the internal space of the case that covers the diaphragm, whereby a high sound pressure is output in this frequency. Accordingly, in the piezoelectric speakers disclosed in Japanese Unexamined Patent Application Publication Nos. 2008-199266 and H06-138882, it is impossible to output a high sound pressure in a wide band.

In the piezoelectric speaker disclosed in International Patent Publication No. WO 2017/029768, a high sound pressure can be output in a wide band. However, intensive studies conducted by the present inventors have revealed that, in the piezoelectric speaker disclosed in International Patent Publication No. WO 2017/029768, irregularities of the sound pressure level in a wide band may occur. The irregularities of the sound pressure level in a wide band means that the sound pressure level does not become flat in a wide band and a frequency in which the sound pressure level becomes relatively small and a frequency in which the sound pressure level becomes relatively large occur.

The present disclosure has been made in view of the aforementioned background, and provides a piezoelectric speaker capable of properly suppressing the occurrence of irregularities of the sound pressure level in a wide band.

A speaker according to one aspect of the present disclosure includes: a plurality of diaphragms, each having a rectangular principal surface; and a cover that has a box shape and is arranged to cover one surface of the principal surface of each of the diaphragms, the cover being arranged so that an air chamber is formed between the cover and the one surface of the principal surface of each of the diaphragms, in which the cover includes an opening formed on one of surfaces of the cover perpendicular to the principal surface of each of the diaphragms. The aforementioned speaker may further include a plurality of piezoelectric elements, and the plurality of diaphragms may be vibrated by expansion/contraction of the plurality of piezoelectric elements. In the aforementioned speaker, the lengths of long sides of the principal surfaces of the plurality of diaphragms may be different from one another.

In the aforementioned speaker, the principal surfaces of the plurality of diaphragms may be on one plane and the long sides of the principal surfaces of the plurality of diaphragms may be aligned.

In the aforementioned speaker, the opening may be formed on a surface of the cover perpendicular to a short side of the principal surface of each of the diaphragms.

In the aforementioned speaker, the width of the opening in the direction in which the plurality of diaphragms are aligned may be equal to or larger than the total length of the long sides of the plurality of diaphragms.

An image display apparatus according to one aspect of the present disclosure is an image display apparatus in which an image display unit is provided on one surface of a housing, and the aforementioned speaker is arranged in such a way that the long-side direction of the opening extends along an outer periphery of the housing and that the opening is located on a surface of the housing in which the image display unit is provided.

According to the present disclosure, it is possible to provide a piezoelectric speaker capable of properly suppressing the occurrence of irregularities of the sound pressure level in a wide band.

The above and other objects, features and advantages of the present disclosure will become more fully understood from the detailed description given hereinbelow and the accompanying drawings which are given by way of illustration only, and thus are not to be considered as limiting the present disclosure.

### BRIEF DESCRIPTION OF DRAWINGS

FIG. 1 is a perspective view schematically showing a structure of a piezoelectric speaker according to an embodiment;

FIG. 2 is a cross-sectional view taken along the line II-II of FIG. 1;

FIG. 3 is an exploded perspective view schematically showing an internal structure of the piezoelectric speaker according to this embodiment;

FIG. 4 is a schematic view describing an example of a movement of two diaphragms when an electric signal is supplied to piezoelectric elements and the piezoelectric elements are expanded/contracted (when the deflection directions are the same);

FIG. 5 is a schematic view describing an example of the movement of the two diaphragms when the electric signal is supplied to the piezoelectric elements and the piezoelectric elements are expanded/contracted (when the deflection directions are opposite to each other);

FIG. 6 is a graph showing results of measuring a sound pressure frequency characteristic; and

FIG. 7 is a perspective view schematically showing an external view of an image display apparatus on which the piezoelectric speaker according to this embodiment is mounted.

### DESCRIPTION OF EMBODIMENTS

Hereinafter, with reference to the drawings, an embodiment of the present disclosure will be explained. A piezoelectric speaker according to this embodiment can be suitably applied to audio/visual equipment including image display apparatuses such as a flat TV, a notebook PC (a personal computer), a tablet PC, a mobile telephone, a liquid crystal display, and a plasma display, and audio apparatuses such as a portable music player and a car audio.

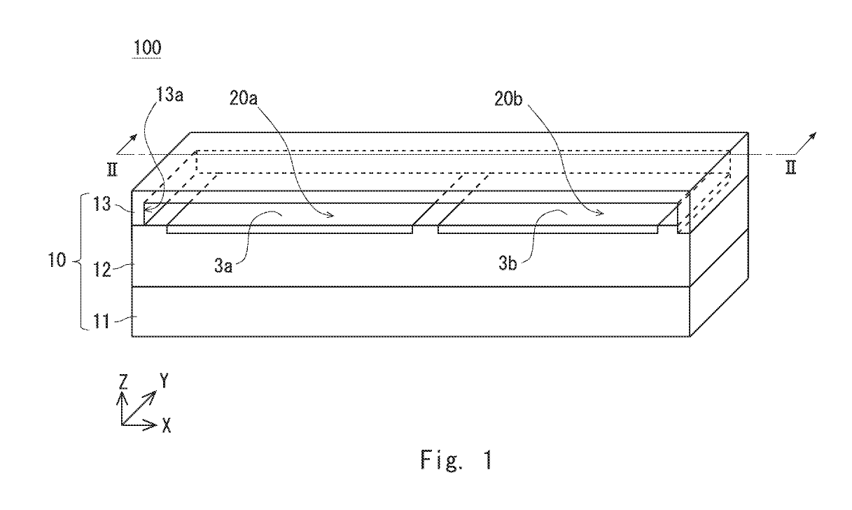

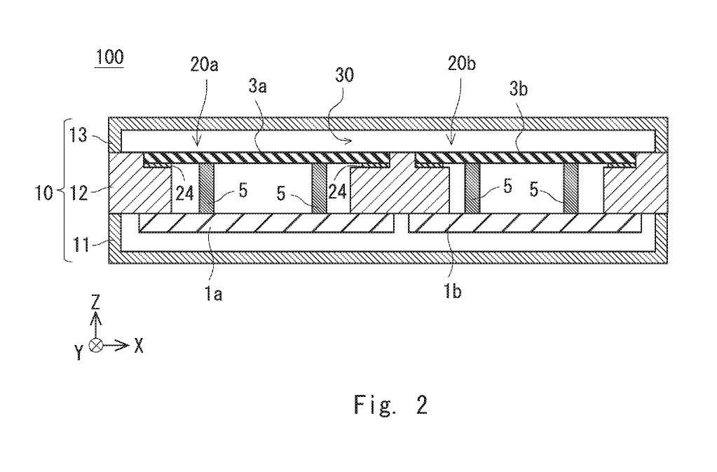

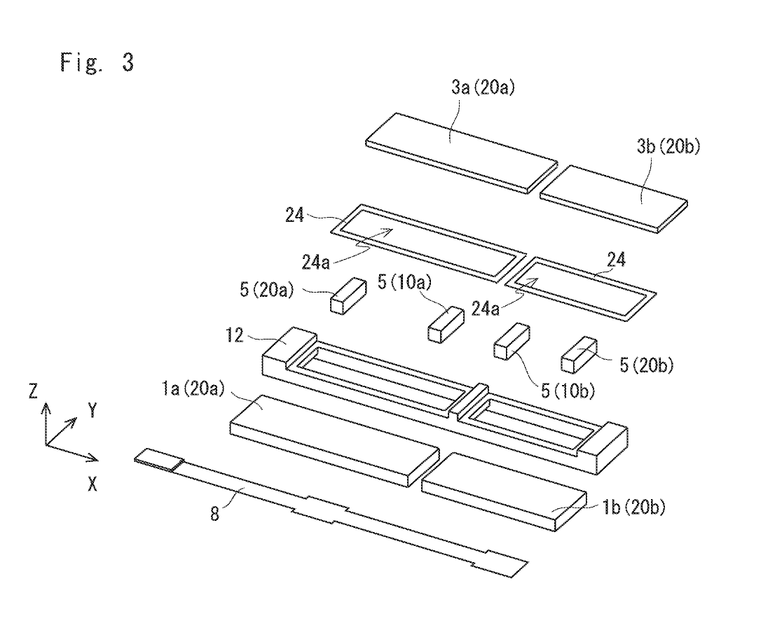

With reference first to FIGS. 1, 2, and 3, a schematic structure of a piezoelectric speaker 100 according to this embodiment will be explained. FIG. 1 is a perspective view schematically showing the structure of the piezoelectric speaker 100. FIG. 2 is a cross-sectional view taken along the line II-II of FIG. 1. FIG. 3 is an exploded perspective view schematically showing an internal structure of the piezoelectric speaker 100. In the following description, for the clarity of the description, descriptions will be given using a three-dimensional orthogonal coordinate system having an X axis, a Y axis, and a Z axis as shown in FIGS. 1, 2, and 3.

As shown in FIGS. 1 and 2, the piezoelectric speaker 100 includes a plurality of piezoelectric units (a first piezoelectric unit 20a and a second piezoelectric unit 20b), and a case 10 that accommodates the first piezoelectric unit 20a and the second piezoelectric unit 20b. The basic structure of the first piezoelectric unit 20a is the same as that of the second piezoelectric unit 20b. The first piezoelectric unit 20a includes a piezoelectric element 1a, a diaphragm 3a, and spacers 5 that couple together the piezoelectric element 1a and the diaphragm 3a. In a similar way, the second piezoelectric unit 20b includes a piezoelectric element 1b, a diaphragm 3b, and spacers 5 that couple together the piezoelectric element 1b and the diaphragm 3b.

The piezoelectric elements 1a and 1b are actuators that convert electric energy into mechanical energy. In this example, a piezoelectric bimorph is used for the piezoelectric elements 1a and 1b. However, an element other than the piezoelectric bimorph (e.g., a piezoelectric unimorph) may be used for the piezoelectric elements 1a and 1b. The principal surface of the piezoelectric element 1a and the principal surface of the piezoelectric element 1b are rectangular flat plates. As shown in FIGS. 1 and 3, in the piezoelectric elements 1a and 1b, the thickness direction is the Z direction and the principal surface is the XY plane. Further, the direction of the long side of the principal surface (long-side direction) in each of the piezoelectric elements 1a and 1b is the X direction, and the direction of the short side of the principal surface (short-side direction) in each of the piezoelectric elements 1a and 1b is the Y direction. In the following description, the surface in the positive side of the Z direction of the principal surface is referred to as a front surface, and the surface in the negative side of the Z direction of the principal surface is referred to as a rear surface.

The length of the long side of the principal surface of the piezoelectric element 1a and the length of the long side of the principal surface of the piezoelectric element 1b are different from each other. For example, the size of the piezoelectric element 1a (the long side of the principal surfacexthe short side of the principal surfacexthickness) is 16 mm×6 mm×1.1 mm, and the size of the piezoelectric element 1b (the long side of the principal surfacexthe short side of the principal surfacexthickness) is 12 mm×6 mm×1.1 mm.

Each of the piezoelectric elements 1a and 1b is supported by a frame 12 at the respective ends thereof in the X direction. That is, in each of the piezoelectric elements 1a and 1b, the respective ends thereof in the X direction are bonded to the frame 12 by using, for example, double-faced tape. Except for their respective ends, the piezoelectric elements 1a and 1b are not restrained. Further, each of the piezoelectric elements 1a and 1b is connected to a Flexible Printed Circuits (FPC) 8 (see FIG. 3) to supply electric signals.

The diaphragms 3a and 3b are vibrated by expansion/contraction of the piezoelectric elements and emit a sound. The principal surface of each of the diaphragms 3a and 3b is a rectangular shim plate. The diaphragms 3a and 3b are arranged in such a way that one surface (rear surface) of each of the principal surfaces is opposed to a corresponding one of the front surfaces of the piezoelectric elements 1a and 1b. That is, the thickness direction of the diaphragms 3a and 3b is the Z direction, and the principal surface of each of the diaphragms 3a and 3b is the XY plane. The principal surface of the diaphragm 3a and the principal surface of the diaphragm 3b are on one plane. Further, in each of the diaphragms 3a and 3b, the direction of the long side of the principal surface (long-side direction) is the X direction, and the direction of the short side of the principal surface (short-side direction) is the Y direction. The long side of the principal surface of the diaphragm 3a and that of the diaphragm 3b are aligned. The diaphragms 3a and 3b are formed of, for example, metal such as SUS (stainless steel).

The width of the long-side direction (X direction) of the diaphragm 3a used for the first piezoelectric unit 20a is different from that of the diaphragm 3b used for the second piezoelectric unit 20b. For example, the size of the diaphragm 3a (the long side of the principal surfacexthe short side of the principal surfacexthickness) is 16 mm×6 mm×1.1 mm, and the size of the diaphragm 3b (the long side of the principal surfacexthe short side of the principal surfacexthickness) is 12 mm×6 mm×1.1 mm.

The respective ends in the X direction of the diaphragms 3a and 3b are fixed to the frame 12 via an elastic body 24. The elastic body 24 serves as a fixing material that fixes the respective ends in the X direction of the diaphragms 3a and 3b to the frame 12. The elastic body 24 is, for example, elastic double-faced tape. The elastic body 24 is formed in a rectangular frame shape (see FIG. 3). That is, the elastic body 24 includes a rectangular opening part 24a provided at the center thereof. The elastic body 24 is arranged in such a way that it is opposed to the peripheral part of the rear surface of each of the diaphragms 3a and 3b. The elastic body 24 is formed in such a way that it does not protrude beyond the edge of each of the diaphragms 3a and 3b.

The piezoelectric element 1a and the diaphragm 3a are coupled to each other via the spacers 5. That is, one end of the spacer 5 is attached to the rear surface of the diaphragm 3a and the other end thereof is attached to the front surface of the piezoelectric element 1a. Accordingly, the diaphragm 3a and the piezoelectric element 1a are arranged in such a way that they are opposed to each other with an interval therebetween in the Z direction. The spacers 5 transfer vibrations between the piezoelectric element 1a and the diaphragm 3a. In a similar way, the piezoelectric element 1b and the diaphragm 3b are coupled to each other via the spacers 5. That is, one end of the spacer 5 is attached to the rear surface of the diaphragm 3b and the other end thereof is attached to the front surface of the piezoelectric element 1b. Accordingly, the diaphragm 3b and the piezoelectric element 1b are arranged in such a way that they are opposed to each other with an interval therebetween in the Z direction. The spacers 5 transfer vibrations between the piezoelectric element 1b and the diaphragm 3b. The spacers 5 are plate-like members. The spacers 5 may be made of, for example, resin such as Teflon (registered trademark).

While the two spacers 5 are used for each of the coupling of the piezoelectric element 1a and the diaphragm 3a and the coupling of the piezoelectric element 1b and the diaphragm 3b in FIG. 2, the number of spacers 5 used for the coupling is not particularly limited. Further, the shape and the material of the spacers 5 are not particularly limited as long as the vibration can be transferred between the piezoelectric element 1a and the diaphragm 3a and between the piezoelectric element 1b and the diaphragm 3b.

As shown in FIGS. 1 and 2, the case 10 includes a lower housing 11, a frame 12, and a cover 13. As described above, the frame 12 is provided to fix the respective ends in the X direction of the front surfaces of the piezoelectric elements 1a and 1b and the respective ends in the X direction of the rear surface of the diaphragms 3a and 3b. The lower housing 11 has a box shape, and is attached to the frame 12 in such a way as to cover the rear surfaces of the piezoelectric elements 1a and 1b. The cover 13 has a box shape and is attached to the frame 12 in such a way as to cover one surface (front surface) of each of the principal surfaces of the diaphragm 3a and the diaphragm 3b. An air chamber 30 (see FIG. 2) is formed between the inner side of the cover 13 and the front surface of the diaphragm 3a and the front surface of the diaphragm 3b. An opening 13a is formed in one of the surfaces of the cover 13 that are perpendicular to the principal surfaces of the diaphragm 3a and the diaphragm 3b. In FIG. 1, the opening 13a is formed on a surface of the cover 13 that is perpendicular to the principal surfaces of the diaphragm 3a and the diaphragm 3b and is perpendicular to the short side of the principal surfaces of the diaphragm 3a and the diaphragm 3b. That is, the opening 13a is formed in the negative side in the Y direction of the cover 13.

The frame 12 is preferably made of, for example, a rigid body having a thickness of about 1 mm. The frame 12 is formed of, for example, SUS. The lower housing 11 and the cover 13 may be made of, for example, a metallic material such as aluminum or may be a resin material such as acryl.

Next, the movement of the diaphragms 3a and 3b when an electric signal is supplied to the piezoelectric elements 1a and 1b and the piezoelectric elements 1a and 1b are expanded/contracted in the first piezoelectric unit 20a and the second piezoelectric unit 20b shown in FIG. 2 will be explained.

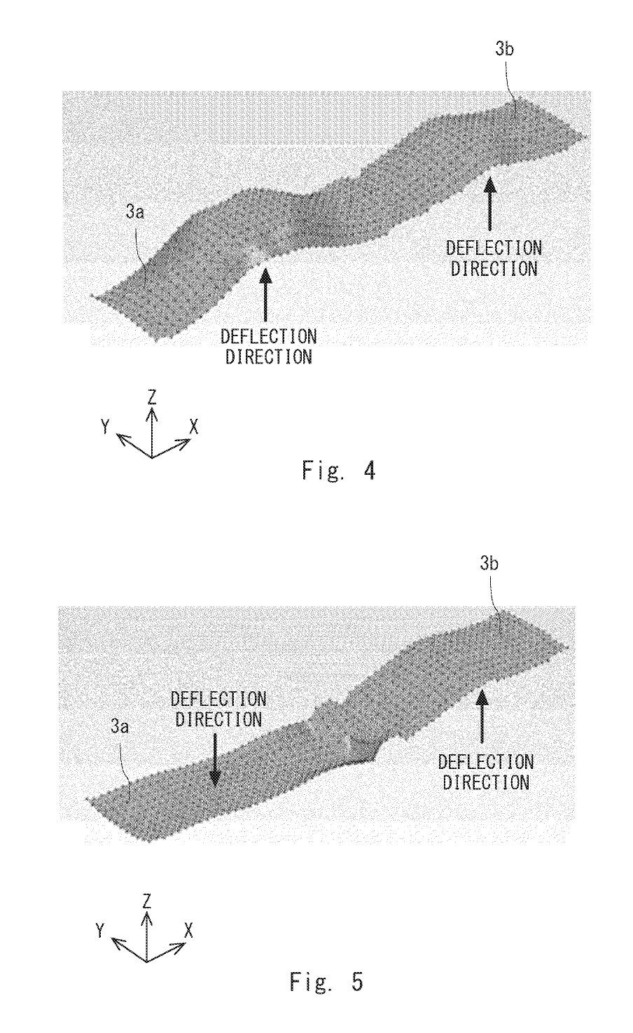

FIGS. 4 and 5 are schematic views describing an example of the movement of the diaphragms 3a and 3b when the electric signal is supplied to the piezoelectric elements 1a and 1b and the piezoelectric elements 1a and 1b are expanded/contracted. It is assumed that the size of the piezoelectric element 1a and the diaphragm 3a is 16 mm×6 mm×1.1 mm, and the size of the piezoelectric element 1b and the diaphragm 3b is 12 mm×6 mm×1.1 mm.

FIG. 4 shows the movement of the diaphragms 3a and 3b when the sound pressure is 3 kHz. As shown in FIG. 4, the deflection direction of the diaphragm 3a becomes the same as that of the diaphragm 3b. That is, when the diaphragm 3a is deflected in the positive side in the Z direction, the diaphragm 3b is deflected in the positive side in the Z direction. In a similar way, when the diaphragm 3a is deflected in the negative side in the Z direction, the diaphragm 3b is deflected in the negative side in the Z direction. The air in the air chamber 30 is converted into the sound pressure when it is discharged from the opening 13a. In the case shown in FIG. 4, the air movement due to the flexural movement of the diaphragm 3a is synchronized with the air movement due to the flexural movement of the diaphragm 3b. Therefore, the amount of the air discharged from the opening 13a increases and the sound pressure level becomes relatively large.

FIG. 5 shows the movement of the diaphragms 3a and 3b when the sound pressure is 6 kHz. As shown in FIG. 5, the deflection direction of the diaphragm 3a becomes opposite to the deflection direction of the diaphragm 3b. That is, when the diaphragm 3a is deflected in the negative side in the Z direction, the diaphragm 3b is deflected in the positive side in the Z direction. In a similar way, when the diaphragm 3a is deflected in the positive side in the Z direction, the diaphragm 3b is deflected in the negative side in the Z direction.

In the case shown in FIG. 5, the deflection direction of the diaphragm 3a and the deflection direction of the diaphragm 3b are opposite to each other. Therefore, if the cover 13 is not provided, the air movement due to the flexural movement of the diaphragm 3a and the air movement due to the flexural movement of the diaphragm 3b cancel out each other. Accordingly, the sound pressure level becomes relatively small.

Further, assume a case in which the cover 13 is provided and the length of the long side of the diaphragm 3a and the length of the long side of the diaphragm 3b are made the same in the case shown in FIG. 5. In the air chamber 30, the amount of the increase in the volume of the air chamber 30 due to the deflection of the diaphragm 3a in the positive side in the Z direction becomes equal to the amount of the decrease in the volume of the air chamber 30 due to the deflection of the diaphragm 3b in the negative side in the Z direction. In a similar way, the amount of the decrease in the volume of the air chamber 30 due to the deflection of the diaphragm 3a in the negative side in the Z direction becomes equal to the amount of the increase in the volume of the air chamber 30 due to the deflection of the diaphragm 3b in the positive side in the Z direction. Therefore, in the air chamber 30, the air movement due to the flexural movement of the diaphragm 3a and the air movement due to the flexural movement of the diaphragm 3b cancel out each other. Therefore, since little air flows in the air chamber 30 and little air is discharged from the opening 13a, it can be considered that the sound pressure level becomes relatively small. However, this canceling is reduced in an area other than the area between the diaphragms 3a and 3b in the air chamber 30, and air may be discharged from at least one of the respective ends in the long side direction of the opening 13a. Further, the number of modes in which the sound pressure is completely cancelled in the diaphragm 3a and the diaphragm 3b is extremely small, and there are a lot of modes in which the sound pressure is not completely canceled out each other.

On the other hand, in the piezoelectric speaker 100 according to this embodiment, due to the presence of the cover 13, the air chamber 30 is formed between the diaphragms 3a and 3b and the length of the long side of the diaphragm 3a is made different from the length of the long side of the diaphragm 3b. When the length of the long side of the diaphragm 3a is different from the length of the long side of the diaphragm 3b, in the case shown in FIG. 5, in the air chamber 30, a difference is generated between the amount of the increase in the volume in the air chamber 30 due to the deflection of the diaphragm 3a in the positive side and the amount of the decrease in the volume in the air chamber 30 due to the deflection of the diaphragm 3b in the negative side. In a similar way, in the air chamber 30, a difference is generated between the amount of the decrease in the volume in the air chamber 30 due to the deflection of the diaphragm 3a in the negative side and the amount of the increase in the volume in the air chamber 30 due to the deflection of the diaphragm 3b in the positive side. That is, the amount of the air drawn into the air chamber 30 due to the deflection of one diaphragm in the negative side in the Z direction is not balanced with the amount of the air discharged from the air chamber 30 due to the deflection of the other diaphragm in the positive side. Therefore, a flow of the air occurs in the air chamber 30. This flow of the air promotes the discharge of the air from the opening 13a. Therefore, the sound pressure level becomes relatively higher than that shown in FIG. 5.

In the cover 13 (see FIG. 1), the opening 13a in the direction in which the plurality of diaphragms are aligned (the width of the opening 13a in the X direction) is preferably made equal to or larger than the total length of the long sides of the plurality of diaphragms. That is, the width of the opening 13a in the X direction is preferably set to a value that is equal to or larger than the sum of the length of the long side of the principal surface of the diaphragm 3a and the length of the long side of the principal surface of the diaphragm 3b (in this example, 16 mm+12 mm=28 mm or larger). According to this structure, when the deflection directions of the two diaphragms become opposite to each other, the flow of the air into the air chamber 30 can be efficiently promoted. In the piezoelectric speaker 100 according to this embodiment, the opening 13a is formed in one of the surfaces of the cover 13 that are perpendicular to the principal surfaces of the diaphragm 3a and the diaphragm 3b. On the other hand, when the opening is formed in a plurality of surfaces of the cover 13 that are perpendicular to the principal surfaces of the diaphragm 3a and the diaphragm 3b, the direction in which the air is discharged from the air chamber 30 is dispersed. Therefore, it is not preferable to form the opening in the plurality of surfaces of the cover 13.

When the width of the opening 13a in the Z direction is made too narrow, the air resistance becomes large in the opening 13a. Therefore, hardly any air is drawn into the air chamber 30, and the flow of the air in the air chamber 30 is not promoted. When the width of the opening 13a in the Z direction is made too large, the flow of the air in the air chamber 30 is not promoted, which is similar to the case in which the cover 13 is not provided. It is therefore preferable to set the width of the opening 13a in the Z direction from 0.2 mm or larger to 1 mm or smaller.

From the aforementioned discussion, it is seen that the piezoelectric speaker 100 according to this embodiment includes the plurality of piezoelectric units (the first piezoelectric unit 20a and the second piezoelectric unit 20b), each including the piezoelectric element and the diaphragm, and the length of the long side of the diaphragm 3a in the first piezoelectric unit 20a is made different from the length of the long side of the diaphragm 3b in the second piezoelectric unit 20b. Further, the cover 13 that covers these diaphragms is provided and the air chamber 30 is formed between the diaphragms 3a and 3b. Further, the opening 13a that opens in the direction parallel to the principal surfaces of the diaphragm 3a and the diaphragm 3b is provided in the cover 13. According to this structure, even when the two diaphragms are vibrated at the frequency at which the deflection directions become opposite to each other, a flow of the air occurs in the air chamber 30 and a discharge of the air from the opening 13a is promoted. Therefore, the sound pressure level becomes relatively high. It is therefore possible to properly suppress the occurrence of irregularities of the sound pressure level in a wide band.

Hereinafter, effects of this embodiment will be explained in comparison with a comparative example.

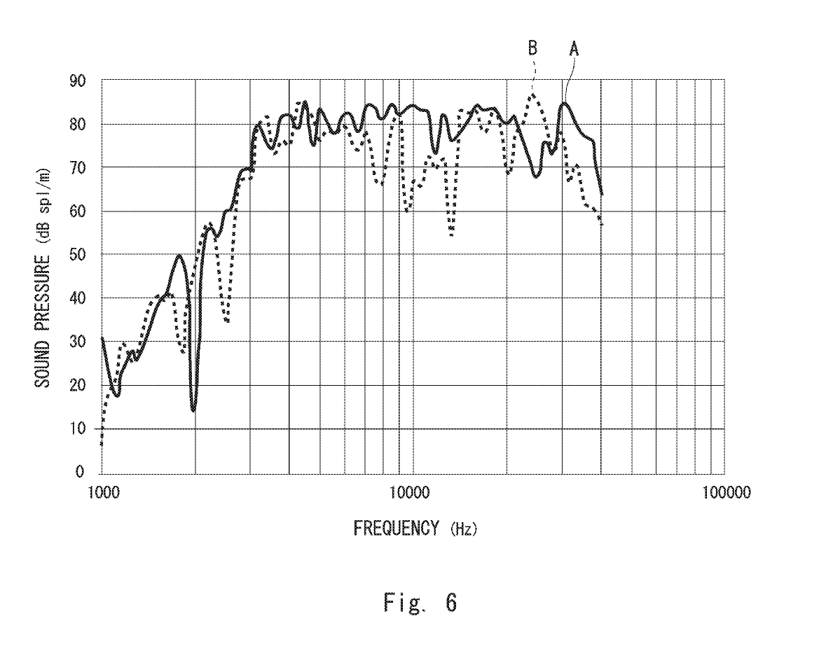

FIG. 6 is a graph showing results of measuring a sound pressure frequency characteristic. In FIG. 6, A indicates the sound pressure frequency characteristic in the Example, and B indicates the sound pressure frequency characteristic according to a comparative example. The piezoelectric speaker according to the Example is the piezoelectric speaker 100 whose structure has been described with reference to FIGS. 1 to 3. The piezoelectric speaker according to the comparative example is a speaker obtained by removing the cover 13 from the piezoelectric speaker 100.

Further, in the Example and the comparative example, the size of the piezoelectric element 1a (the long side of the principal surfacexthe short side of the principal surfacexthickness) is 16 mm×6 mm×1.1 mm, and the size of the piezoelectric element 1b (the long side of the principal surfacexthe short side of the principal surfacexthickness) is 12 mm×6 mm×1.1 mm. The size of the diaphragm 3a (the long side of the principal surfacexthe short side of the principal surfacexthickness) is 16 mm×6 mm×1.1 mm, and the size of the diaphragm 3b (the long side of the principal surfacexthe short side of the principal surfacexthickness) is 12 mm×6 mm×1.1 mm. The width of the opening 13a in the X direction is set to the sum (28 mm) of the length of the long side of the principal surface of the diaphragm 3a and the length of the long side of the principal surface of the diaphragm 3b. Further, the width of the opening 13a in the Z direction is 0.5 mm.

As shown in FIG. 6, in a range in which the frequency is from 3 kHz to 20 kHz, in the comparative example, irregularities are seen in the graph, and there are some parts in the graph where the sound pressure becomes lower than 70 dBm. On the other hand, in this Example, the graph is almost flat, and the sound pressure is always kept to be equal to or larger than 70 dBm. From the aforementioned discussion, it has been confirmed that the piezoelectric speaker 100 according to this embodiment contributes to proper suppression of the occurrence of irregularities of the sound pressure level in a wide band.

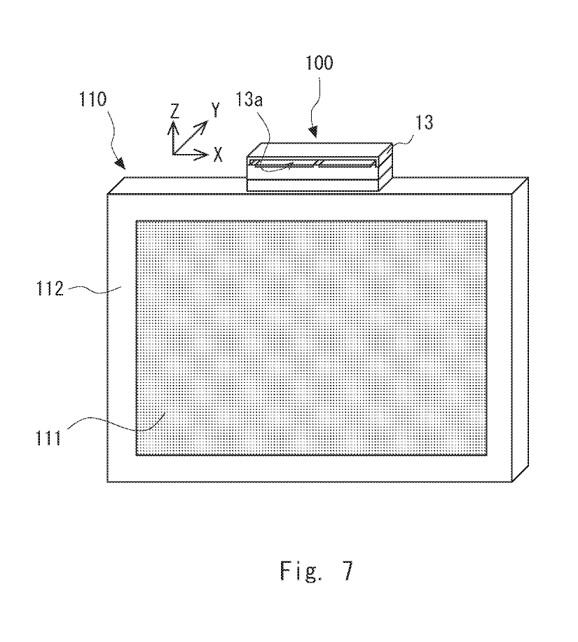

FIG. 7 is a perspective view schematically showing an external view of an image display apparatus 110 such as a flat TV on which the piezoelectric speaker 100 according to this embodiment is mounted. As shown in FIG. 7, the image display apparatus 110 includes an image display unit 111 provided on one surface of a housing 112. The piezoelectric speaker 100 is arranged in such a way that the long-side direction of an opening 13a extends along the outer periphery of the housing 112 and the opening 13a is positioned on the side of the housing 112 in which the image display unit 111 is provided. Regarding the shape of the piezoelectric speaker 100 (see FIG. 1), in the diaphragm 3a and the diaphragm 3b, the length of the direction of the long side of the principal surface (long-side direction) is long and the length of the direction of the short side of the principal surface (short-side direction) is short. Therefore, the piezoelectric speaker 100 is optimally mounted on the image display apparatus 110 such as the flat TV having a small thickness. Further, since the opening 13a that emits a sound is provided on the surface of the housing 112 in which the image display unit 111 is provided, the sound emitted from the opening 13a can be directly delivered to the user who is viewing the image display unit 111.

While the present disclosure has been described above with reference to the aforementioned embodiment and the Example, it is needless to say that the present disclosure is not limited to the structure of the aforementioned embodiment and the Example and that the present disclosure includes various changes, modifications, and combinations that will be made by one skilled in the art within the scope of the disclosure set forth in the claims. Furthermore, while the two piezoelectric units have been provided in the aforementioned embodiment, this is merely an example and three or more piezoelectric units may be provided.

In the aforementioned embodiment, the plurality of diaphragms (the diaphragm 3a and the diaphragm 3b) are arranged in such a way that the principal surfaces of the plurality of diaphragms are on one plane and that the long sides of the principal surfaces are aligned, and the direction of the long sides of these diaphragms is made to coincide with the long-side direction of the opening 13a in the cover 13. According to this structure, the piezoelectric speaker can be made large only in the long-side direction and can be made short in the short-side direction. This structure contributes to a high space efficiency when the piezoelectric speaker 100 is mounted on the aforementioned image display apparatus. However, the method of arranging the plurality of diaphragms is not necessarily limited to this method.

While the piezoelectric elements and the diaphragms are coupled to each other by the spacers in the plurality of piezoelectric units in the aforementioned embodiment, this is merely an example. The piezoelectric elements and the diaphragms may be coupled to each other using double-faced tape or adhesive such as silicone resins or epoxy resins.

While the speaker is a piezoelectric speaker that vibrates the diaphragms by the piezoelectric elements in the aforementioned embodiment, this is merely an example. The speaker according to the present disclosure may be a speaker that vibrates the diaphragms by a vibration generator other than the piezoelectric elements.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A speaker comprising:
a plurality of diaphragms, each having a rectangular principal surface; and a cover that has a box shape and is arranged to cover one surface of the principal surface of each of the diaphragms, the cover being arranged so that an air chamber is formed between the cover and the one surface of the principal surface of each of the diaphragms, herein the cover includes an opening formed on one of surfaces of the cover perpendicular to the principal surface of each of the diaphragms.

2. The speaker according to claim 1, further comprising a plurality of piezoelectric elements, wherein the plurality of diaphragms are vibrated by expansion/contraction of the plurality of piezoelectric elements.

3. The speaker according to claim 2, wherein the lengths of long sides of the principal surfaces of the plurality of diaphragms are different from one another.

4. The speaker according to claim 3, wherein the principal surfaces of the plurality of diaphragms are on one plane and the long sides of the principal surfaces of the plurality of diaphragms are aligned.

5. The speaker according to claim 4, wherein the opening is formed on a surface of the cover perpendicular to a short side of the principal surface of each of the diaphragms.

6. The speaker according to claim 5, wherein the width of the opening in the direction in which the plurality of diaphragms are aligned is equal to or larger than the total length of the long sides of the plurality of diaphragms.

7. An image display apparatus, wherein an image display unit is provided on one surface of a housing, and the speaker according to claim 5 is arranged in such a way that the long-side direction of the opening extends along an outer periphery of the housing and that the opening is located on a surface of the housing in which the image display unit is provided.
